(19) United States
(12) Patent Application Publication
(10) Pub. No.: US 2017/0192652 A1
(43) Pub. Date: Jul. 6, 2017

(54) METHOD AND ELECTRONIC DEVICE FOR ADJUSTING DISPLAY INTERFACE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jiong Wang, Beijing (CN)

(21) Appl. No.: 15/243,784

(22) Filed: Aug. 22, 2016

Related U.S. Application Data
(63) Continuation of application No. PCT/CN2016/089074, filed on Jul. 7, 2016.

(30) Foreign Application Priority Data
Dec. 30, 2015 (CN) 201511021060.2

(51) Int. Cl. G06F 3/0484

(52) U.S. Cl. CPC G06F 3/04845; G06F 2203/04803

(57) ABSTRACT

The present disclosure discloses a method and an electronic device for adjusting display interface. The method includes: monitoring a drag operation of a user on the display interface, where a screen includes at least two display interfaces, and the display interface displays program information; and moving the display interface when the drag operation is completed so that borders of the display interface are aligned to display borders of the screen.

### CROSS-REFERENCES TO RELATED APPLICATIONS

This application is a continuation application of a PCT application No. PCT/CN2016/089074, filed on Jul. 7, 2016, which claims priority to Chinese Patent Application No. 201511021060.2, titled “METHOD AND APPARATUS FOR ADJUSTING DISPLAY INTERFACE” and filed to the State Intellectual Property Office on Dec. 30, 2015, the entire content of both applications is incorporated herein by reference.

### TECHNICAL FIELD

The present disclosure relates to computer technologies, for example, to a method and an electronic device for adjusting display interface.

### TECHNICAL BACKGROUND

With developments of science and technology, it is common for users to watch videos on smart terminal devices through video play software.

A home page of the video play software is generally divided into multiple continuous display interfaces for displaying program information. For example, a home page is divided into nine display interfaces in three rows and three columns, each display interface displays respective program information which generally is a video snapshot or a video cover. A user may select any row to transversely slide or vertically slide the whole home page, so as to display other display interfaces for acquiring more program information.

In the above solution, a layout of display interfaces becomes disordered after being transversely and vertically slid by the user for many times, which is disadvantageous for program information displaying.

### SUMMARY

The present disclosure provides a method and an electronic device for adjusting display interface, so as to implement that display interfaces can be adaptively adjusted after a drag operation, so that a whole layout remains unchanged and it is convenient to display program information.

In a first aspect, embodiments of the present disclosure provide a method for adjusting display interface, which is applied to an electronic device, including:

monitoring a drag operation of a user on the display interface, where a screen includes at least two display interfaces, and the display interface is configured to display program information; and

moving the display interface when the drag operation is completed so that borders of the display interface are aligned to display borders of the screen.

In a second aspect, embodiments of the present disclosure further provide an electronic apparatus for adjusting display interface, including:

at least one processor; and

a memory communicably connected with the at least one processor for storing instructions executable by the at least one processor, wherein execution of the instructions by the at least one processor causes the at least one processor to:

monitor a drag operation of a user on the display interface, where a screen includes at least two display interfaces, and the display interface is configured to display program information; and

move the display interface when the drag operation is completed, so that borders of the display interface are aligned to display borders of the screen.

In a third aspect, embodiments of the present disclosure further provide a non-transitory computer-readable storage medium storing executable instructions that, when executed by an electronic device, cause the electronic device to:

monitor a drag operation of a user on the display interface, wherein a screen includes at least two display interfaces, and the display interface is configured to display program information; and

move the display interface when the drag operation is completed so that borders of the display interface are aligned to display borders of the screen.

### DESCRIPTION OF DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flowchart showing a method for adjusting display interface according to Embodiment I of the present disclosure;

FIG. 2 is a diagram showing a layout of a display interface before a drag operation of a user according to Embodiment I of the present disclosure;

FIG. 3 is a diagram showing a layout of a display interface during a drag operation of a user according to Embodiment I of the present disclosure;

FIG. 4 is a schematic diagram showing a draggable direction of a display interface according to Embodiment I of the present disclosure;

FIG. 5 is a flowchart showing a method for adjusting display interface according to Embodiment II of the present disclosure;

FIG. 6 is a schematic diagram showing a method for adjusting display interface according to Embodiment II of the present disclosure;

FIG. 7 is a flowchart showing a method for adjusting display interface according to Embodiment III of the present disclosure;

FIG. 8 is a schematic diagram showing a method for adjusting display interface according to Embodiment III of the present disclosure;

FIG. 9 is a flowchart showing a method for adjusting display interface according to Embodiment IV of the present disclosure;

FIG. 10 is a structural diagram showing an apparatus for adjusting display interface according to Embodiment V of the present disclosure; and

FIG. 11 is a functional block diagram of an electronic device according to Embodiment VII of the present disclosure.

### DETAILED DESCRIPTION OF EMBODIMENT

The following describes in detail the present disclosure with reference to the accompanying drawings and embodiments. It is to be understood that embodiments set forth herein are merely intended to interpret the present disclosure and are not intended to limit the present disclosure. In addition, it should be noted that for ease of description, drawings merely show parts related to the present disclosure instead of all parts.

### Embodiment I

FIG. 1 is a flowchart showing a method for adjusting display interface according to Embodiment I of the present disclosure, this embodiment is applicable to a case that program information is selected by dragging the display interface in a terminal device, and the method can be executed by a smart terminal device such as a smart mobile phone. The method includes following steps.

In Step 101, a drag operation of a user on the display interface is monitored; where a screen includes at least two display interfaces, and the display interface is configured to display program information.

The screen is divided by display interfaces into multiple areas which may be equal to or unequal to each other. Each display interface displays corresponding program information, and the program information may be a video cover or a video snapshot for a user to browse and select. Quantity of display interfaces in the screen can be randomly set as at least two, and optionally nine display interfaces in three rows and three columns. The display interface can be moved according to the drag operation of the user, and optionally, a whole row of display interface can be transversally moved, and all display interfaces in the screen can be vertically moved together. The drag operation of the user on the display interface is monitored, and Step 102 is executed after the drag operation of the user on the display interface is monitored.

In Step 102, the display interface is moved when the drag operation is completed, so that borders of the display interface are aligned to display borders of the screen.

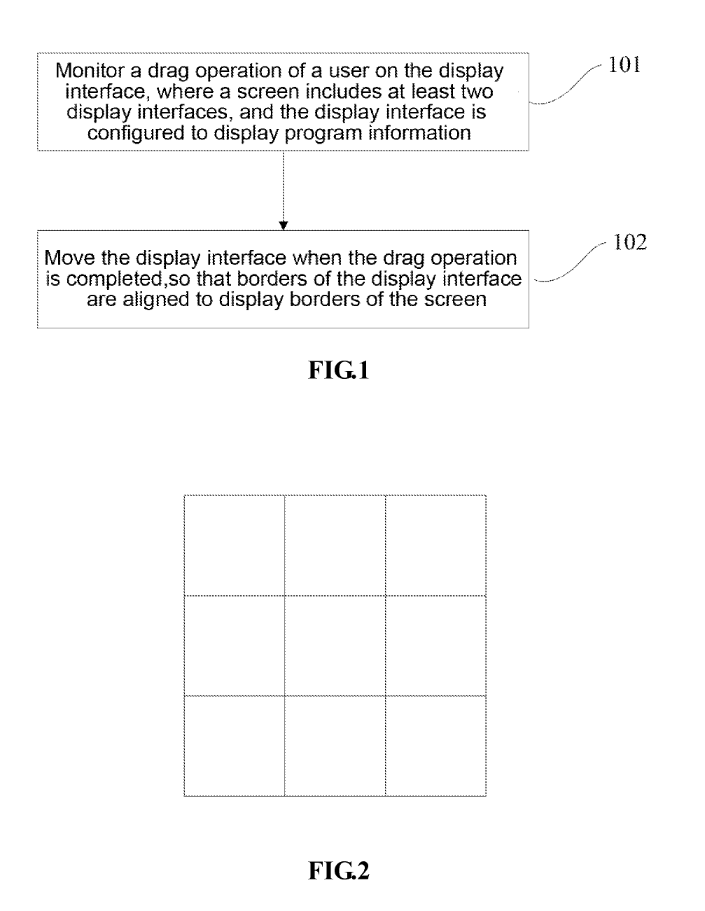

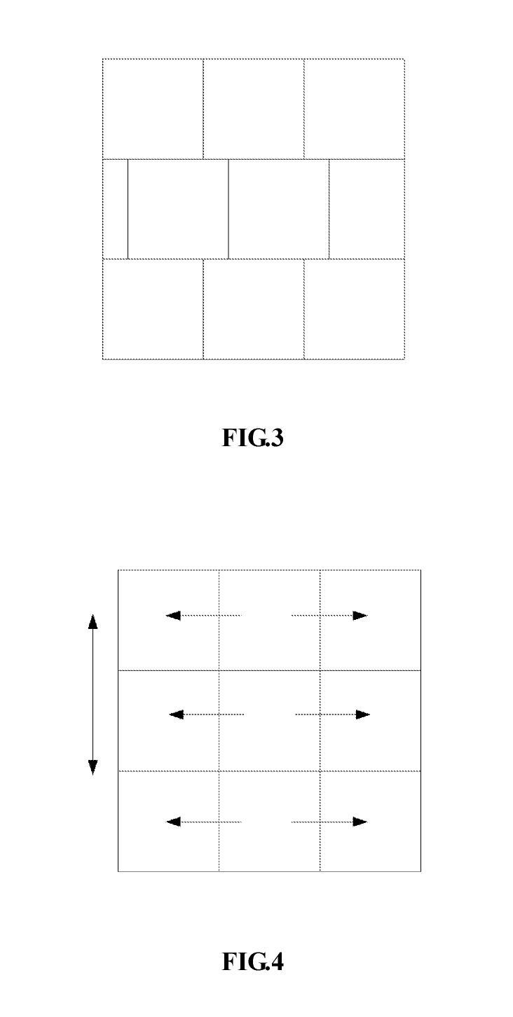

The display interface generally is a consecutively-arranged square area, borders of the display interface are four sides of the square area including an upper side, a lower side, a left side and a right side, and display borders of the screen are four sides at an outermost side of the whole screen including an upper side, a lower side, a left side and a right side. When the drag operation is completed, the display interface is moved so that the borders of the display interface are aligned to the display borders of the screen, and finally the display interface is recovered as a layout mode before the drag operation. For example, before the drag operation, the whole screen displays nine display interfaces as nine grids in three rows and three columns, the nine display interfaces are aligned in rows and columns according to nine grids, as shown in FIG. 2, which is a diagram showing a layout of a display interface before a drag operation of a user according to Embodiment I of the present disclosure. When the user executes the drag operation, for example, drags a row in the middle to acquire other display interfaces and obtain program information, the layout of display interfaces may be disrupted, as shown in FIG. 3, which is a diagram showing a layout of a display interface during a drag operation of a user according to Embodiment I of the present disclosure. When the drag operation is completed, the display interfaces automatically move and recover as the layout of display interfaces as shown in FIG. 2. As for moving of display interfaces, a part of display interfaces in the screen or all the display interfaces can be moved. In a case that a part of display interfaces are moved, each display interface of which interface scope is not covered within the screen among current display interfaces may be recognized and moved so that borders of the display interface are aligned to borders of the screen. Borders of the display interface can also be aligned to borders of the screen by reducing borders of a display interface or by maintaining a size of each display interface unchanged while reducing distances between display interfaces.

In the technical solution of this embodiment, by monitoring a drag operation of a user on a display interface, the display interface is moved when the drag operation is completed, so that borders of the display interface are aligned to display borders of the screen, thereby solving a problem that a layout becomes disordered and thus it is disadvantageous for program information displaying after the user transversally and vertically slides display interfaces for many times, implementing that display interfaces can be adaptively adjusted after the drag operation, so that the whole layout remains unchanged, and it is convenient to display program information.

In the above solution, optionally, monitoring the drag operation of the user on the display interface includes at least one of following items: monitoring a transverse drag operation of the user on the display interface; and monitoring a vertical drag operation of the user on the display interface. The user may perform transverse and vertical operations on the display interface, as shown in FIG. 4, which is a schematic diagram showing a draggable direction of a display interface according to Embodiment I of the present disclosure. Each row of the display interface can be subjected to a transverse drag operation, and all the display interfaces can be subjected to a vertical drag operation simultaneously.

In the above solution, optionally, recognizing that the drag operation is completed includes: acquiring a point-in-time at which a current drag operation is completed; and determining that a current continuous drag operation is completed when no next drag operation is monitored within preset time since the point-in-time at which the current drag operation is completed. After it is determined that the continuous drag operation is completed, the display interfaces can be moved to recover a regular layout.

In the above solution, optionally, moving the display interface so that borders of the display interface are aligned to display borders of the screen includes at least one of following items: transversely moving the display interface so that the borders of the display interface are aligned to the display borders of the screen; and vertically moving the display interface so that the borders of the display interface are aligned to the display borders of the screen.

Since drag directions of the display interface include a transverse direction and a vertical direction, correspondingly, adjustment moving direction of the display interface may be a transverse direction or a vertical direction.

### Embodiment II

FIG. 5 is a flowchart showing a method for adjusting display interface according to Embodiment II of the present disclosure, on a basis of the above embodiment, this embodiment provides a selectable solution in a process of moving and adjusting the display interface, and the method includes following steps.

In Step 501, a drag operation of a user on the display interface is monitored, where a screen includes at least two display interfaces, and the display interface is configured to display program information; and

In Step 502, the display interface is moved to a direction of which a distance is shorter, according to a distance from borders of the display interface to display borders of the screen, so that the borders of the display interface are aligned to the display borders of the screen.

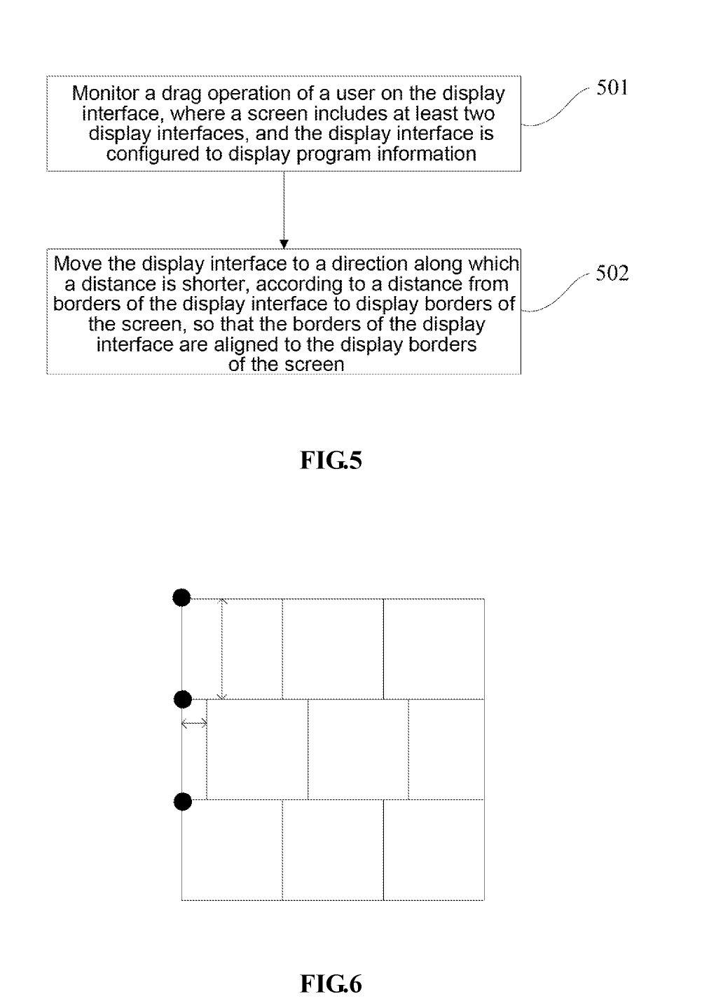

The distance from the borders of the display interface to the display borders of the screen can be determined by a distance from one point selected on the borders of the screen to the borders of the display interface. As shown in FIG. 6, which is a schematic diagram showing a method for adjusting display interface according to Embodiment II of the present disclosure. A focal point of a left border of the screen is selected as a reference point, and a distance from the reference point to a left border of the display interface in a selected row is as shown by arrows in FIG. 6. When transverse drag of the display interface in this row is completed, it is determined that the display interface in this row is to be moved to the left when the distance is less than or equal to a half width of the display interface, and the display interface in this row is to be moved to the right when the distance is greater than the half width of the display interface. Similarly, when the whole display interface is vertically moved, a distance from a reference point in an upper left corner of the screen to an upper border or a lower border of the display interface is compared with a half length of the display interface, and the display interface is moved to a direction of which the distance is shorter.

In the technical solution of this embodiment, by monitoring a drag operation of a user on a display interface, the display interface is moved to a direction of which a distance is shorter, according to the distance from borders of the display interface to display borders of the screen when the drag operation is completed, so that the borders of the display interface are aligned to the display borders of the screen, thereby solving a problem that a layout becomes disordered and thus it is disadvantageous for program information displaying after the user transversally and vertically slides display interfaces for many times; meanwhile, moving distance of the display interface is the shortest and user experience is good, thereby implementing that display interfaces can be adaptively adjusted after the drag operation, so that the whole layout remains unchanged, and it is convenient to display program information.

### Embodiment III

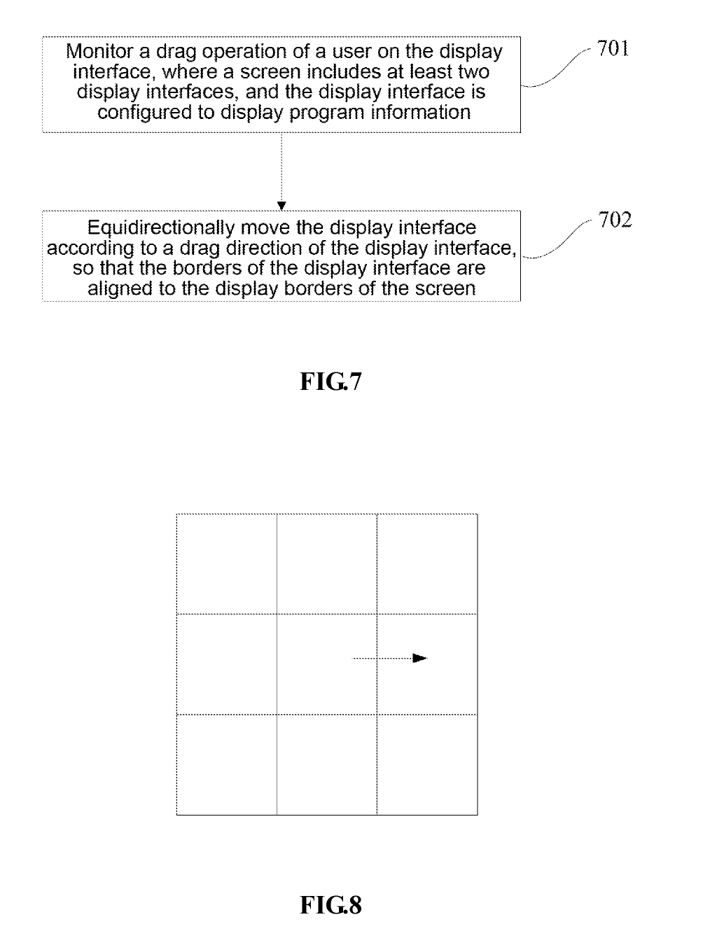

FIG. 7 is a flowchart showing a method for adjusting display interface according to Embodiment III of the present disclosure, on a basis of the above embodiments, this embodiment provides a selectable solution in the process of moving and adjusting the display interface, and the method includes following steps.

In Step 701, a drag operation of a user on the display interface is monitored, where a screen includes at least two display interfaces, and the display interface is configured to display program information; and

In Step 702, the display interface is equi-directionally moved according to a drag direction of the display interface, so that the borders of the display interface are aligned to the display borders of the screen.

A moving process is as shown in FIG. 8, which is a schematic diagram showing a method for adjusting display interface according to Embodiment III of the present disclosure. The user drags a display interface in a middle row to slide to the right; in this case, when the drag operation is completed, the display interface in this row is moved to the right so as to recover the layout of the original nine grids. Similarly, when the user drags the display interface to the left, upwardly or downwardly, the display interface is equi-directionally moved according to the drag direction of the user, so that the borders of the display interface are aligned to the display borders of the screen.

In the technical solution of this embodiment, by monitoring a drag operation of a user on a display interface, the display interface is equi-directionally moved according to the drag direction of the display interface when the drag operation is completed, so that borders of the display interface are aligned to display borders of the screen, thereby solving a problem that a layout becomes disordered and thus it is disadvantageous for program information displaying after many times of drag operations of the user on display interfaces. Meanwhile, display interfaces, of which displaying are completed, are preferentially removed from the screen according to application scenarios that program information is displayed in the display interfaces, which conforms to requirements for browsing program information by the user.

### Embodiment IV

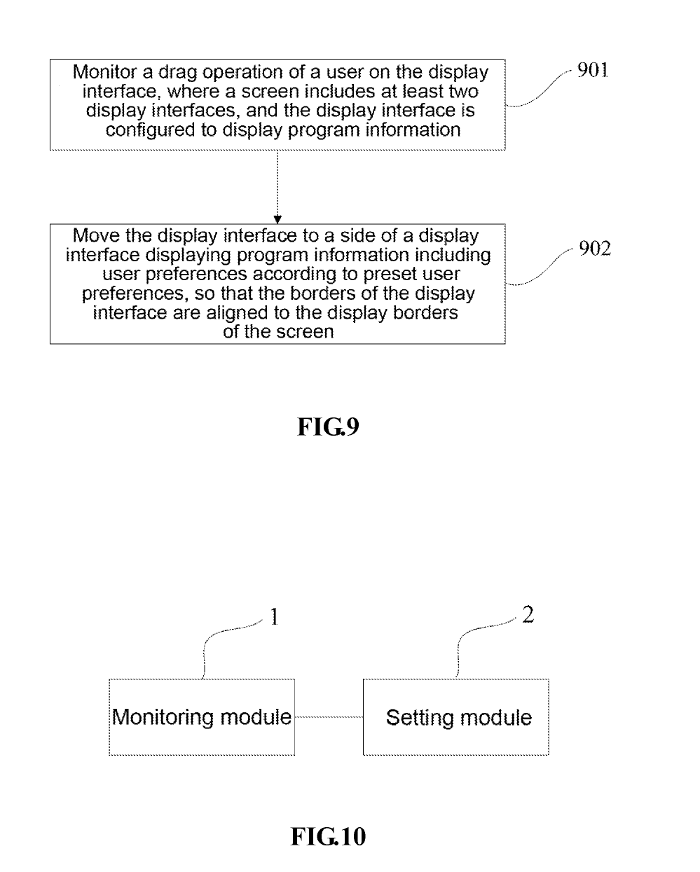

FIG. 9 is a flowchart showing a method for adjusting display interface according to Embodiment IV of the present disclosure, on a basis of the above embodiments, this embodiment provides a selectable solution in the process of moving and adjusting the display interface, and the method includes following steps.

In Step 901, a drag operation of a user on the display interface is monitored, where a screen includes at least two display interfaces, and the display interface is configured to display program information; and

In Step 902, the display interface is moved to a side of a display interface displaying program information including user preferences according to preset user preferences, so that the borders of the display interface are aligned to the display borders of the screen.

The preset user preferences can be manually input by the user, for example, preferences such as “sports”, “movies” and the like are input, and the preset user preferences can also be obtained by collating records of program information selected by the user. When the display interface needs to be moved transversally or vertically so as to maintain the original layout, optionally, the display interface is moved to a side of a display interface displaying program information including user preferences, so that the borders of the display interface are aligned to the display borders of the screen; and in this case, program information displayed in the display interface includes program information preferred by the user.

In the technical solution of this embodiment, by monitoring a drag operation of a user on a display interface, the display interface is moved to a side of a display interface displaying program information including the user preferences according to preset user preferences when the drag operation is completed, so that the borders of the display interface are aligned to the display borders of the screen, thereby solving a problem that a layout becomes disordered and thus it is disadvantageous for program information displaying after many times of drag operations of the user on display interfaces; and meanwhile, moving of the display interface is more intelligent.

### Embodiment V

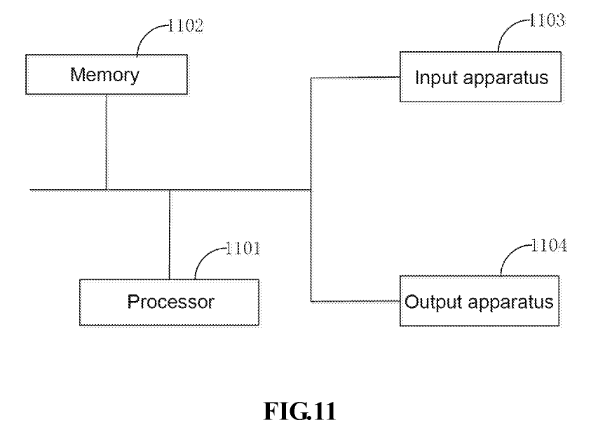

FIG. 10 is a structural diagram showing an apparatus for adjusting display interface according to Embodiment V of the present disclosure, as shown in FIG. 10, the apparatus includes:

a monitoring module 1, monitors a drag operation of a user on the display interface, where a screen includes at least two display interfaces, and the display interface displays program information; and

a setting module 2, moves the display interface when the drag operation is completed, so that borders of the display interface are aligned to display borders of the screen.

In the technical solution of this embodiment, by monitoring a drag operation of a user on a display interface through the monitoring module 1, the setting module 2 moves the display interface when the drag operation is completed, so that borders of the display interface are aligned to display borders of the screen, thereby solving a problem that a layout becomes disordered and thus it is disadvantageous for program information displaying after the user transversally and vertically slides display interfaces for many times, implementing that a whole layout remains unchanged after the drag operation on the display interface, and it is convenient to display program information.

In the above solution, optionally, the monitoring module 1 further executes at least one of following items: monitoring a transverse drag operation of a user on the display interface; and monitoring a vertical drag operation of the user on the display interface.

In the above solution, optionally, the setting module 2 further acquires a point-in-time at which a current drag operation is completed; and determines that a current continuous drag operation is completed when no next drag operation is monitored within preset time since the point-in-time at which the current drag operation is completed.

In the above solution, optionally, the setting module 2 further executes at least one of following items: transversely moving the display interface so that the borders of the display interface are aligned to the display borders of the screen; and vertically moving the display interface so that the borders of the display interface are aligned to the display borders of the screen.

In the above solution, optionally, the setting module 2 further moves the display interface to a direction of which a distance is shorter, according to a distance from the borders of the display interface to the display borders of the screen, so that the borders of the display interface are aligned to the display borders of the screen.

In the above solution, optionally, the setting module 2 further equi-directionally moves the display interface according to a drag direction of the display interface, so that the borders of the display interface are aligned to the display borders of the screen.

In the above solution, optionally, the setting module 2 further moves the display interface to a side of a display interface displaying program information including user preferences according to preset user preferences, so that the borders of the display interface are aligned to the display borders of the screen.

The above products can execute the method provided by any embodiment of the present disclosure, and have corresponding functional modules for executing the method.

### Embodiment VI

Embodiments of the present disclosure provide a non-transitory computer-readable storage medium storing computer-executable instructions, which can execute the method for adjusting display interface according to any of the above method embodiments.

### Embodiment VII

FIG. 11 is a functional block diagram showing a hardware structure of a device executing the method for adjusting display interface according to Embodiment V of the present disclosure, as shown in FIG. 11, the device includes:

at least one processor 1101 and a memory 1102; where one processor 1101 is taken as an example in FIG. 11.

The device may further include: an input apparatus 1103 and an output apparatus 1104.

The processor 1101, the memory 1102, the input apparatus 1103 and the output apparatus 1104 in the device may be connected by means of a bus or in other ways; where a connection by means of a bus is taken as an example in FIG. 11.

As a non-transitory computer readable storage medium, the memory 1102 can store non-transitory software programs, non-transitory computer executable programs and modules such as program instructions/modules (for example, the monitoring module 1 and the setting module 2 as shown in FIG. 10) corresponding to the method for adjusting display interface in embodiments of the present disclosure. The processor 1101 executes various function applications and data processing of a server, namely implement the method for adjusting display interface in the above method embodiments, by running the non-transitory software programs, instructions and modules stored in the memory 1102.

The memory 1102 may include a program storage area and a data storage area, where the program storage area can store an operating system, application programs required for at least one function; and the data storage area can store data created according to use of a terminal device. Besides, the memory 1102 can include a high speed random access memory, and may further include a non-transitory memory, such as at least one magnetic disk storage device, a flash memory, or other non-transitory solid-state storage devices. In some embodiments, the memory 1102 optionally includes memories disposed remotely relative to the processor 1101, and these remote memories can be connected to a terminal device via a network. Instances of the above network include but are not limited to an Internet, an Intranet, a local area network (LAN), a mobile communication network and a combination thereof.

The input apparatus 1103 can receive input numerical or character information, and generate key signal input related to user settings and function control a terminal. The output apparatus 1104 may include a display device such as a display screen and the like.

The at least one module is stored in the memory 1102, and executes the method for adjusting display interface in any of the above method embodiments when being executed by the at least one processor 1101.

The above products may execute the method provided by embodiments of the present disclosure, and have corresponding functional modules for executing the method and beneficial effects. Reference is made to the method provided by embodiments of the present disclosure for technical details not elaborated in this embodiment.

The electronic apparatus in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipad), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic apparatus having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions making a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the above embodiments, those of ordinary skill in the art should understand that technical solutions recorded in the above embodiments can be modified, or parts of the technical solutions can be equally replaced; and the modification and replacement dose not make essential of corresponding technical solutions depart from spirits and scope of technical solutions of various embodiments.

What is claimed is:

1. A method for adjusting a display interface, executed by an electronic device, comprising:
monitoring a drag operation of a user on the display interface, wherein a screen includes at least two display interfaces, and the display interface is configured to display program information; and
moving the display interface when the drag operation is completed so that borders of the display interface are aligned to display borders of the screen.

2. The method according to claim 1, wherein the moving the display interface so that borders of the display interface are aligned to display borders of the screen comprises at least one of following items:
moving the display interface transversely so that the borders of the display interface are aligned to the display borders of the screen; and
moving the display interface vertically so that the borders of the display interface are aligned to the display borders of the screen.

3. The method according to claim 1, wherein the moving the display interface so that borders of the display interface are aligned to display borders of the screen comprises:
moving the display interface to a direction of which a distance is shorter, according to a distance from the borders of the display interface to the display borders of the screen, so that the borders of the display interface are aligned to the display borders of the screen.

4. The method according to claim 1, wherein the moving the display interface so that borders of the display interface are aligned to display borders of the screen comprises:
moving the display interface equi-directionally according to a drag direction of the display interface, so that the borders of the display interface are aligned to the display borders of the screen.

5. The method according to claim 1, wherein the moving the display interface so that borders of the display interface are aligned to display borders of the screen comprises:
moving the display interface to a side of a display interface displaying program information including user preferences according to preset user preference, so that the borders of the display interface are aligned to the display borders of the screen.

6. The method according to claim 1, wherein the recognizing that the drag operation is completed comprises:
acquiring a point-in-time at which a current drag operation is completed; and
determining that a current continuous drag operation is completed when no next drag operation is monitored within preset time since the point-in-time at which the current drag operation is completed.

7. An electronic device, comprising:
at least one processor; and
a memory communicably connected with the at least one processor for storing instructions executable by the at least one processor, wherein execution of the instructions by the at least one processor causes the at least one processor to:
monitor a drag operation of a user on the display interface, wherein a screen includes at least two display interfaces, and the display interface is configured to display program information, and
move the display interface when the drag operation is completed, so that borders of the display interface are aligned to display borders of the screen.

8. The electronic device according to claim 7, wherein the instructions to move the display interface so that borders of the display interface are aligned to display borders of the screen cause the at least one processors to perform at least one of following items:
move the display interface transversely so that the borders of the display interface are aligned to the display borders of the screen; and
move the display interface vertically so that the borders of the display interface are aligned to the display borders of the screen.

9. The electronic device according to claim 7, wherein the instructions to move the display interface so that borders of the display interface are aligned to display borders of the screen cause the at least one processors to:
move the display interface to a direction of which a distance is shorter, according to a distance from the borders of the display interface to the display borders of the screen, so that the borders of the display interface are aligned to the display borders of the screen.

10. The electronic device according to claim 7, wherein the instructions to move the display interface so that borders of the display interface are aligned to display borders of the screen cause the at least one processors to:
move the display interface equi-directionally according to a drag direction of the display interface, so that the borders of the display interface are aligned to the display borders of the screen.

11. The electronic device according to claim 7, wherein the instructions to move the display interface so that borders of the display interface are aligned to display borders of the screen cause the at least one processors to:
move the display interface to a side of a display interface displaying program information including user preferences according to preset user preferences, so that the borders of the display interface are aligned to the display borders of the screen.

12. The electronic device according to claim 7, wherein the instructions to recognize that the drag operation is completed cause the at least one processors to:
acquire a point-in-time at which a current drag operation is completed; and
determine that a current continuous drag operation is completed when no next drag operation is monitored within preset time since the point-in-time at which the current drag operation is completed.

13. A non-transitory computer-readable storage medium storing executable instructions that, when executed by an electronic apparatus, cause the electronic device to:
monitor a drag operation of a user on the display interface, wherein a screen includes at least two display interfaces, and the display interface is configured to display program information; and
move the display interface when the drag operation is completed so that borders of the display interface are aligned to display borders of the screen.

14. The non-transitory computer-readable storage medium according to claim 13, wherein, the instructions to move the display interface so that borders of the display interface are aligned to display borders of the screen cause the electronic device to perform at least one of following items:
move the display interface transversely so that the borders of the display interface are aligned to the display borders of the screen; and
move the display interface vertically so that the borders of the display interface are aligned to the display borders of the screen.

15. The non-transitory computer-readable storage medium according to claim 13, wherein, the instructions to move the display interface so that borders of the display interface are aligned to display borders of the screen cause the electronic device to:
move the display interface to a direction of which a distance is shorter, according to a distance from the borders of the display interface to the display borders of the screen, so that the borders of the display interface are aligned to the display borders of the screen.

16. The non-transitory computer-readable storage medium according to claim 13, wherein, the instructions to move the display interface so that borders of the display interface are aligned to display borders of the screen cause the electronic device to:
move the display interface equi-directionally according to a drag direction of the display interface, so that the borders of the display interface are aligned to the display borders of the screen.

17. The non-transitory computer-readable storage medium according to claim 13, wherein, the instructions to move the display interface so that borders of the display interface are aligned to display borders of the screen cause the electronic device to:
move the display interface to a side of a display interface displaying program information including user preferences according to preset user preferences, so that the borders of the display interface are aligned to the display borders of the screen.

18. The non-transitory computer-readable storage medium according to claim 13, wherein, the instructions to recognize that the drag operation is completed cause the electronic device to: acquire a point-in-time at which a current drag operation is completed; and
determine that a current continuous drag operation is completed when no next drag operation is monitored within preset time since the point-in-time at which the current drag operation is completed.
